(19) United States
(12) Patent Application Publication
(10) Pub. No.: US 2003/0012317 A1
(43) Pub. Date: Jan. 16, 2003

(54) Method for synchronisation of two devices or apparatus connected to a telephone line

(76) Inventors: Fernand Courtois, Saint Contest (FR); Dominique Delbecq, Caen (FR)

Correspondence Address: Steven R Biren, US Philips Corporation, 580 White Plains Road, Tarrytown, NY, 10591, US

(21) Appl. No.: 10/204,655

(22) PCT Filed: Dec. 19, 2001
(86) PCT No.: PCT/IB01/02664

(30) Foreign Application Priority Data
Dec. 28, 2000 (FR) 00/17205

(51) Int. Cl. H04L 7/00

(52) U.S. Cl. 375/354

(57) ABSTRACT

The present invention relates to a method for synchronisation of at least one first device or apparatus (6) with at least one second device or apparatus(7), comprising respectively a first (8) and a second (10) counter modulus n, and which are designed to exchange data by means of a galvanic connection.

The method according to the invention comprises the following steps:

generation by the second device or apparatus (7) of a clock signal, which acts as a counting basis for the second counter (10);

transmission of this clock signal to the first device or apparatus (8); and

transmission of the data of the second device or apparatus (7) to the first device or apparatus (6), at instants which are separated by at least two cycles of the clock signal, and, each time the second counter (10) is re-initialised, transmission to the first device or apparatus (6) of a synchronisation signal comprising two successive time slots of the clock signal.

The invention is applied in the field of transmissions, and relates more particularly to a method for synchronisation of at least one first device or apparatus with at least one second device or apparatus, comprising respectively a first and a second modulus n, counter and which are designed to exchange data via a galvanic connection.

An increasing number of devices or apparatus exchange data via a telephone line. Some devices or apparatus receive a first supply voltage from the telephone line, whereas, in addition to this first voltage, other devices or apparatus require a second voltage which must be supplied by a second source.

In order to prevent strong disturbances which occur on the telephone line from affecting the functioning of the devices or apparatus which are fed by the second source, these devices or apparatus are isolated from the telephone line by a galvanic barrier. However, this galvanic barrier must not prevent the devices or apparatus which it isolates from exchanging data.

A known solution consists of producing the galvanic barrier by means of high-voltage capacitors, which are disposed between an interface which is connected to the telephone line, and the devices or apparatus which are fed by the second source.

These capacitors must permit transfers of data between the different devices or apparatus, transfer of the second supply voltage from the second source to the devices or apparatus which are fed by the telephone line, and transfer of synchronization signals.

The data to be transmitted mostly consists of binary transmission TX and reception RX frames, control data intended for the line interface, and state data, which indicates the operating state of the line.

An object of the invention is to provide a method which can detect a lack of synchronisation between the devices or apparatus which are fed by the second source and the line interface, and to re-synchronize these circuits immediately.

According to the invention, this object is achieved by means of a method comprising the following steps:

generation by the second device or apparatus of a clock signal, which acts as a counting basis for the second counter;

transmission of this clock signal to the first device or apparatus; and

transmission of the digital data from the second device or apparatus to the first device or apparatus, at instants which are separated by at least two cycles of the clock signal, and, each time the second counter is re-initialized, transmission to the first device or apparatus of a synchronization signal comprising two successive time slots of the clock signal.

According to one embodiment of the invention, the galvanic connection is provided by means of three high-voltage capacitors C1, C2, and C3, the capacitors C1 and C2 being designed to transmit, from the second device or apparatus to the first device or apparatus, n−2 successive cycles of the clock signal, the capacitor C3 being designed in particular to transmit the following successive two cycles n−1 and n of the clock signal.

According to a particular embodiment of the invention, the first device or apparatus is an interface, which is designed to connect one or a plurality of digital devices or apparatus to a telephone line, and the second device or apparatus is a micro-controller.

According to a variant of this particular embodiment of the invention, the micro-controller transmits continually, and in a loop, to the line interface, for n−2 cycles of the clock signal, a first data packet (TX), which is provided with a first address, and receives in return from the line interface a second data packet (RX), which is provided with a second address, and detects a transmission fault on the line, if the first and second addresses are different.

According to an advantageous embodiment of the invention, the first and second packets (TX), (RX) comprise respectively the contents of a control register and a state register, as well as a memory address which is associated with each register, the first data packet additionally comprising a synchronisation key, the line interface being able to detect the synchronisation key, to de-code the memory address of each register, and to transmit the content of the state register, which is provided with the same address, in the memory of the micro-controller.

According to a particular embodiment of the invention, the contents of each control register and each state register are validated by an error detector code.

According to a preferred embodiment of the invention, before the connection is established between the line interface and the micro-controller, the latter transmits to the line interface a specific binary frame, which makes it possible to initialise the exchange of data, and, if there is a fault on the line, the line interface returns to the micro-controller state data comprising at least one error indication bit.

These and other aspects of the invention are apparent from and will be elucidated, by way of non-limiting example, with reference to the embodiment(s) described hereinafter.

In the drawings:

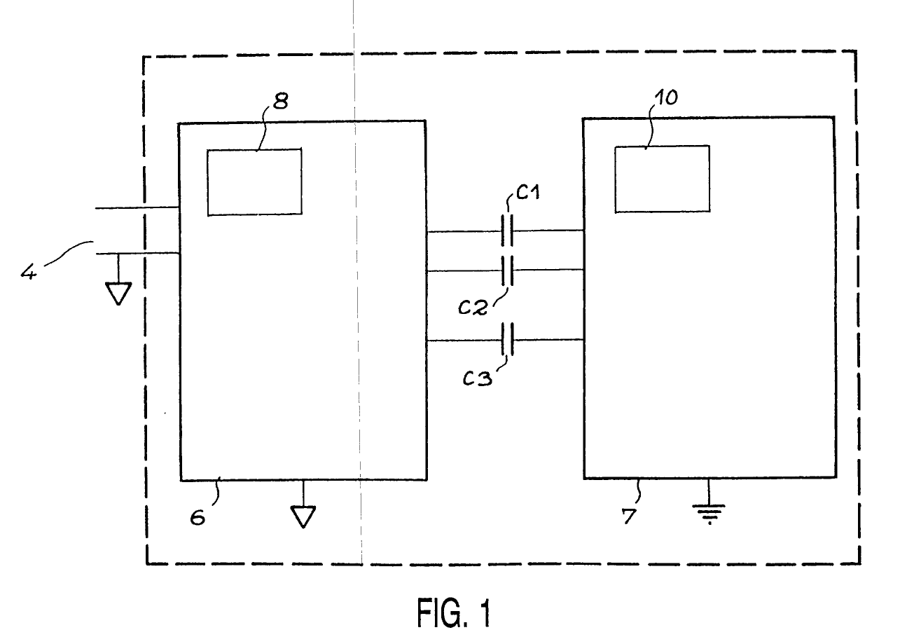

FIG. 1 shows schematically two devices or apparatus which are designed to exchange information, according to the method of the invention;

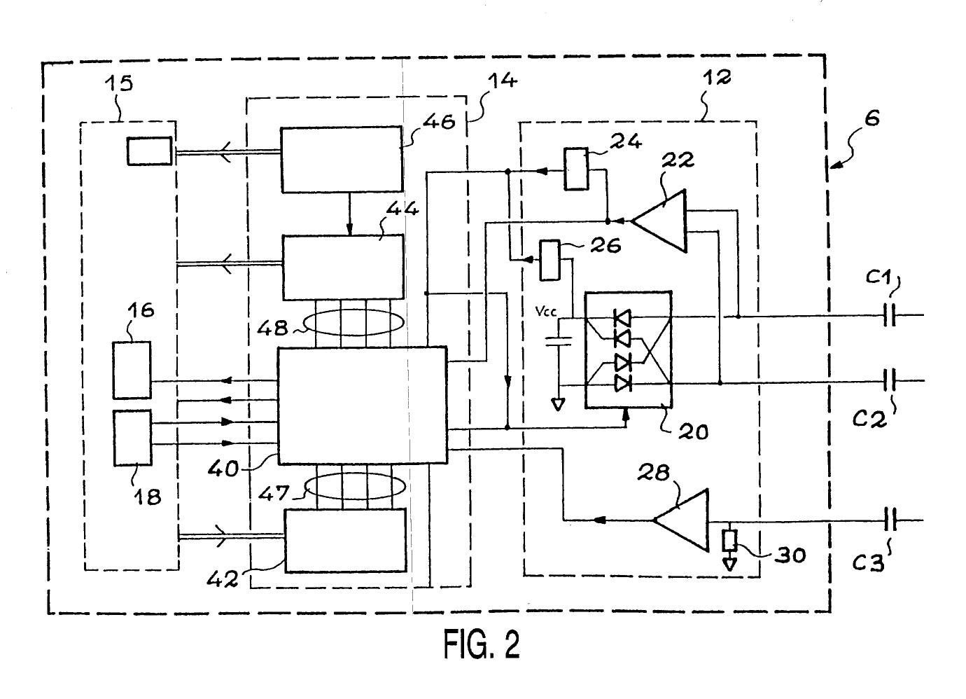

FIG. 2 shows a detailed diagram of the first device or apparatus in FIG. 1;

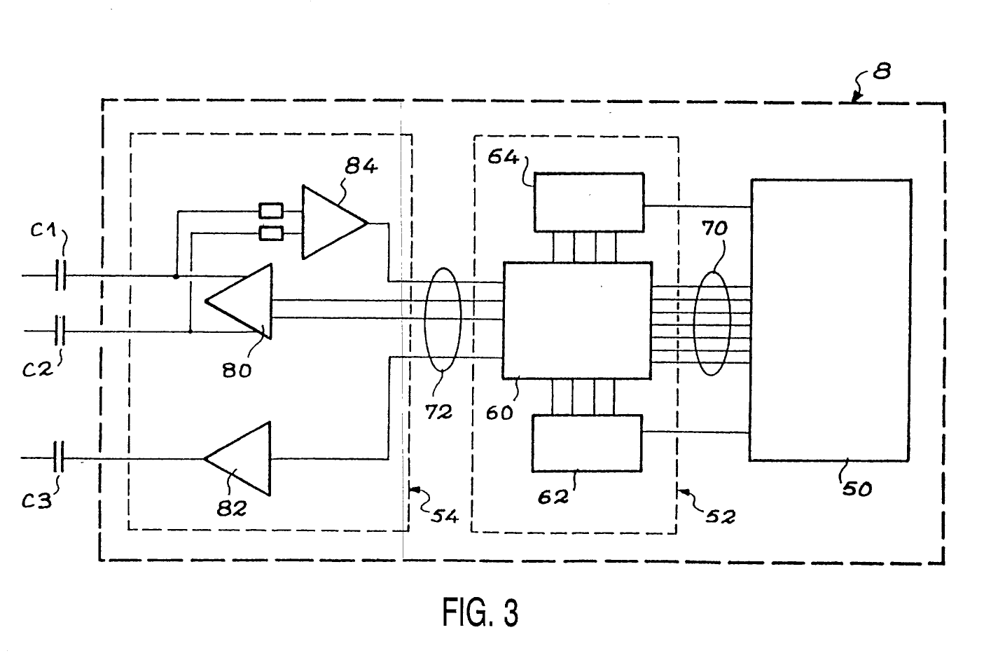

FIG. 3 shows a detailed diagram of the second device or apparatus in FIG. 1;

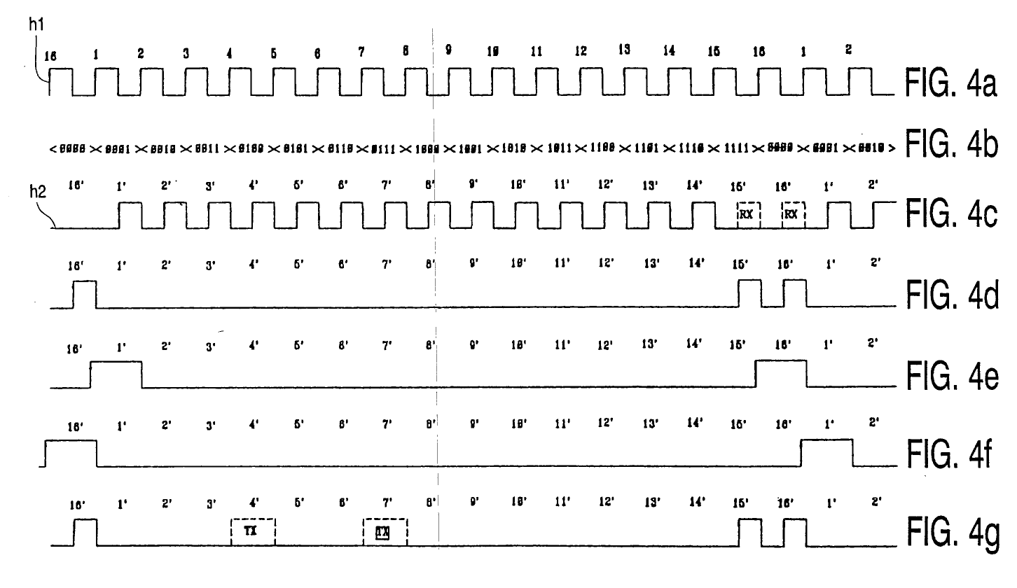

FIG. 4 shows a timing diagram, illustrating the signals transmitted by the second device or apparatus to the first device or apparatus in FIG. 1; and

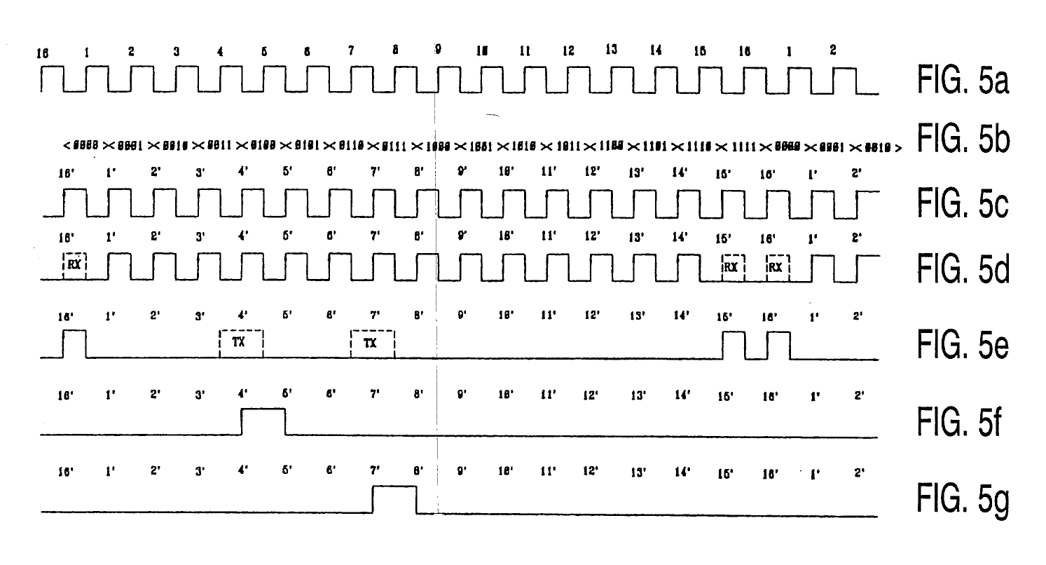

FIG. 5 shows a timing diagram, illustrating the signals received by the first device or apparatus.

In FIG. 1, two devices or apparatus, which are connected to a telephone line 4, are isolated from one another by a galvanic connection, comprising three high-voltage capacitors C1, C2 and C3.

The first device or apparatus 6 is for example a line interface, which is connected to the telephone line 4, and the second device or apparatus 7 is a micro-controller of the line interface 6.

The line interface 6 comprises a counter 8 modulus n, and the micro-controller 7 comprises a counter 10 modulus n. In the continuation of the description, n will for example be equal to 16.

FIG. 2 shows a detailed diagram of the line interface 6. The latter comprises an input stage 12, which assures the connection with the high-voltage capacitors C1, C2 and C3, a digital block 14, in which there are provided digital components, is used to control the telephone line. This digital block 14 communicates with an analogue block 15, comprising a digital-analogue converter 16, and an analogue-digital converter 18.

The input stage 12 comprises a rectifier bridge 20, which is designed to rectify a signal originating respectively from the capacitors C1 and C2, in order to generate a DC supply voltage Vcc of the line interface 6. A comparator 22 is disposed between the capacitors C1 and C2, in order to supply a differential voltage to the digital block 14. The output of the comparator 22 is connected to a clock detection module 24, which is designed to re-initialise the line interface 6, if it detects the lack of signals originating from the capacitors C1 and C2. A switch 26 is disposed between the bridge 20 and the block 14, in order to de-activate the latter when the differential voltage at the output of the comparator 22 is lower than a predetermined threshold.

The capacitor C3 is connected to a first monitoring amplifier 28, which is designed to store a voltage temporarily at the terminals of a resistor 30. This resistor 30 makes it possible to connect the line interface 6 to a ground, when the information supplied to the line interface 6 via the capacitor C3 is not at the logic level “1”.

The digital block 14 comprises a calculation unit 40, a first RAM memory 42, containing five state registers with eight bits, a second RAM memory 44, containing five control registers with eight bits, and a digital line control module 46. The calculation unit 40 is connected to the first RAM memory 42 by a first bus 47, and to the second RAM memory 44 by a second bus 48. The first RAM memory 42 is connected to the analogue block 15, in order to receive logic information, which is representative of the state of the telephone line, and the second RAM memory 44 is connected to the analogue block 15, in order to supply control logic information to this block.

With reference to FIG. 3, the micro-controller 8 comprises a central unit 50, a transmission protocol control stage 52, and an output stage 54, which connects the stage 52 to the capacitors C1, C2 and C3.

The central unit 50 comprises a computer program, comprising a module which is dedicated to control of the transmission protocol, and a module which is dedicated to processing of the control and state information.

The protocol control stage 52 comprises a calculation unit 60, a third RAM memory 62, comprising five state registers with eight bits, and a fourth RAM memory 64, comprising five control registers with eight bits.

The protocol control stage 52 communicates with the central unit 50 via a third bus 70, and with the output stage 54, via a fourth bus 72.

The output stage 54 comprises a differential amplifier 80, which is designed to control the voltages applied to the capacitors C1 and C2, a current detector 82, which is designed to measure the differential voltage between the capacitors C1 and C2, and a second monitoring amplifier 84, which is designed to control the voltage of the capacitor C3.

In operation, the micro-controller 7 transmits digital data and control data TX to the line interface 6, and receives digital data and state data RX from the line interface 6.

FIGS. 4 and 5 constitute respectively a timing diagram illustrating signals exchanged by the micro-controller 7 with the line interface 6, and a timing diagram illustrating signals emitted or received by the line interface 6.

Line 4-a in FIG. 4 illustrates the clock signal h₁ generated by the micro-controller 7, which will be recuperated by the line interface 6, via the galvanic connection. Line 4-b represents the successive states of the counter 10. The latter is re-initialised automatically at the sixteenth cycle of the clock signal h1.

Line 4-c represents the differential signal h₂ at the terminals of the capacitors C1 and C2. This signal assumes the same values as the clock signal h1, for 14 successive cycles of h₁. The fifteenth and sixteenth cycles of h₂ are used in order to receive the signals RX transmitted by the line interface 6. These signals can be “0” or “1”.

With reference to the line 4-d, during the first fourteen cycles of the signal clk12 (states (1) to (14)), the capacitors C1 and C2 are piloted by the control circuit 8, via the differential amplifier 80. During the fifteenth and sixteenth cycles (states (15) and (16)) of the clock signal clk12, the differential amplifier 80 is in a condition of high impedance, and the line interface 6 pilots the rectifier bridge 20.

Lines 4-e and 4-f represent the instants at which the micro-controller 7 receives data RX from the line interface 6.

Line 4-g represents the signal at the terminals of the capacitors C3. During the first fourteen cycles of the clock signal hi, the data TX is transmitted at instants which are separated by at least one clock cycle, and in the example illustrated, these instants correspond to the fourth and seventh clock cycles. The two successive time slots of the fifteenth and sixteenth clock cycles are identified within the calculation unit 40 as constituting a synchronisation signal, which is designed to re-initialise the counter 8, simultaneously with the counter 10.

FIG. 5 illustrates the data and clock signals at the level of the line interface 6.

Line 5-b represents the successive states of the counter 8. The latter is reinitialised automatically, when the signal at the third capacitor C3 has two successive time slots (line 4-d), as previously explained.

Line 5-c illustrates the clock signal hi recuperated by the line interface 6.

Line 5-d illustrates a differential signal h₂, taken from the terminals of the capacitors C1 and C2. This signal assumes the same values as the clock signal h1 for fourteen successive cycles. The fifteenth and sixteenth cycles of h₂ are used to transmit the signals RX to the micro-controller 7.

Line 5-e represents the signal at the terminals of the capacitor C3. During the first fourteen cycles of the clock signal h1, the data TX is transmitted at instants which are separated by at least one clock cycle, and in the example illustrated, these instants correspond to the fourth and seventh clock cycles. The synchronisation signal corresponds to the two successive time slots of the fifteenth and sixteenth clock cycles.

Lines 5f and 5g illustrate respectively the instants at which the data and state signals TX are received by the line interface 6.

1. A method for synchronisation of at least one first device or apparatus (6) with at least one second device or apparatus (7), comprising respectively a first (8) and a second (10) counter modulus n, and which are designed to exchange data via a galvanic connection, which method is characterized in that it comprises the following steps:
generation by the second device or apparatus (7) of a clock signal which acts as a counting basis for the second counter (10);
transmission of this clock signal to the first device or apparatus (6); and
transmission of the data from the second device or apparatus (7) to the first device or apparatus (6), at instants which are separated by at least two cycles of the clock signal, and, each time that the second counter (10) is re-initialised, transmission to the first device or apparatus of a synchronisation signal comprising two successive time slots of the clock signal.

2. A method as claimed in claim 1, characterised in that the galvanic connection is provided by means of three high-voltage capacitors C1, C2 and C3, the capacitors C1 and C2 being designed to transmit from the second device or apparatus (7) to the first device or apparatus (6), n−2 successive cycles of the clock signal, the capacitor C3 being designed in particular to transmit the following successive two cycles n−1 and n of the clock signal.

3. A method as claimed in claim 1, characterized in that the first device or apparatus (6) is an interface, which is designed to connect one or a plurality of devices or apparatus to a telephone line (4), the second device or apparatus (7) being a micro-controller.

4. A method as claimed in claim 3, characterized in that the micro-controller (7) transmits continually, and in a loop, to the line interface (6), for n−2 cycles of the clock signal, a first data packet (TX), which is provided with a first address, and receives in return from the line interface (6) a second data packet (RX), which is provided with a second address, and detects a transmission fault on the line, if the first and the second addresses are different.

5. A method as claimed in claim 4, characterized in that the first and second ackets (TX) and (RX) comprise respectively the contents of a control register and a state register, as well as a memory address which is associated with each register, the first data packet additionally comprising a synchronisation key.

6. A method as claimed in claim 5, characterized in that the line interface (6) detects the synchronisation key, decodes the memory address of each register, and returns the content of the state register, which is provided with the same address, in the memory of the micro-controller (7).

7. A method as claimed in claim 6, characterized in that the contents of each control register and each state register of are validated by an error detector code.

8. A method as claimed in claim 7, characterized in that, before the connection is established between the line interface (6) and the micro-controller (7), the latter transmits to the line interface (6) a specific binary frame, which makes it possible to initialise the exchange of data, and in that, if there is a fault on the line, the line interface (6) returns to the micro-controller (7) state data comprising at least one error indication bit.
